(19) United States
(12) Patent Application Publication
(10) Pub. No.: US 2007/0076674 A1
(43) Pub. Date: Apr. 5, 2007

(54) Apparatus and method locating a mobile communication unit

(76) Inventors: Stuart A. Golden, Portland, OR (US); Jong-Kae Fwu, San Jose, CA (US)

Correspondence Address: Law Office of Donald D. Mondul;c/o PortfolioIP, P.O. Box 52050, Minneapolis, MN, 55402, US

(21) Appl. No.: 11/241,407

(22) Filed: Sep. 30, 2005

(51) Int. Cl. H04Q 7/24

(52) U.S. Cl. 370/338

(57) ABSTRACT

Briefly, in accordance with one embodiment of the invention, a method ascertaining location of a mobile communication unit with respect to at least one fixed access point, each respective location of each respective access point of the at least one fixed access point being known, may include: (a) transmitting a first message from the mobile communication unit; (b) transmitting a second message from at least one responsive fixed access point, the second message being responsive to the first message; (c) measuring at selected stations among the mobile communication unit and the at least one fixed access point time intervals between noting the first message and noting the second message; and (d) employing the measured time intervals at the selected stations for calculating at least one line of position locating the mobile communication unit.

### BACKGROUND

Locating mobile communication units within a system that includes fixed access points (also sometimes embodied in communication base stations) is useful in many instances, including instances requiring a response to a request for help from an operator of a mobile unit. Some prior art locating schemes have involved synchronizing timing among portions of communication systems, such as among mobile communication units and fixed access points. Such synchronization requires additional hardware and software in both mobile units and fixed access points that disadvantageously increase cost, complexity and bulk of various system units.

There is a need for a locating a system and method that requires no explicit time-synchronizing among units. In some instances, it would be further advantageous if the system and method locate a mobile communication unit within the system without requiring data input from the mobile communication unit to be located. The present invention accounts for mobile communications units that are unsynchronized. It is advantageous to deal with responses to packets designed for the implementation of the method of the invention so that the mechanical time-difference of the response to the packet is likely to be close in time to the transmitted packet. Since the packet and response are close in time then the effect of different clock rates will likely be neligible.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a communication system configured according to the present invention;

FIG. 2 illustrates representative signals used in operating the system and method of the present invention;

FIG. 3 is a flow diagram illustrating the method of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like).

Types of cellular radiotelephone communication systems intended to be within the scope of the present invention include, although not limited to, Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like.

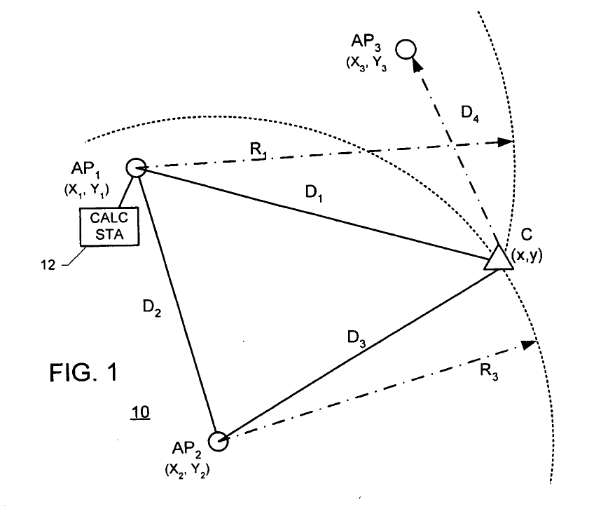

FIG. 1 illustrates a communication system configured according to the present invention. In FIG. 1, a telecommunication system 10 includes a first access point AP₁ located at coordinates (x₁, y₁), a second access point AP₂ located at coordinates (x₂, Y₂), a third access point AP₃ located at coordinates (X₃, y₃) and a mobile station or client C located at coordinates (x, y). A calculation station 12 is illustrated, by way of example and not by way of limitation, as coupled with access point AP₁. Calculation station 12 may be coupled with or included within any of access points AP₁, AP₂, AP₃ or client C. Calculation station 12 may be only connected with fewer than all of access points AP₁, AP₂, AP₃ and client C. Calculation station 12 may be connected with any of access points AP₁, AP₂, AP₃ or client C or less than all of them directly or via a communication link (not shown in detail in FIG. 1).

Because coordinates: (x₁, y₁) (x₂, y₂), (x₃, y₃) are known, distance D₂ between access point AP₁ and access point AP₂ may be known. Distance between access point AP₁ and access point AP₃ may be known. Distance between access point AP₂ and access point AP₃ may be known. Distance D₁ between access point AP₁ and client C is not known. Distance D₃ between access point AP₂ and client C is not known. Distance D₄ between access point AP₃ and client C is not known.

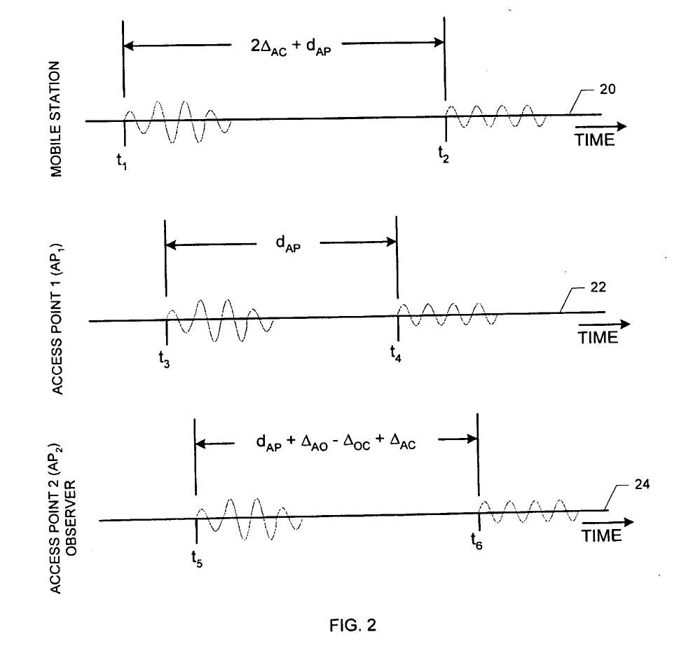

FIG. 2 illustrates representative signals used in operating the system and method of the present invention. In FIG. 2, a time line 20 for mobile station or client C, a time line 22 for access point AP₁ and a time line 24 for access point AP₂ acting in an observer role represent timing of events in telecommunication system 10 (FIG. 1). As indicated in time lines 20, 22, 24, events may occur as follows:
Time t₁: Client C transmits a packet or probe request (PKT₁).
   Probe request PKT₁ is sent at time t₁ as measured on client's C clock.
Time t₃: Access point AP₁ receives PKT₁.
   Probe request PKT₁ arrives at access point AP₁ at time t₃ as measured on the access point's AP₁ clock.
   Access point AP₁ exhibits some delay in responding to probe request PKT₁ and replies back with an acknowledgement RSP₁.
   Acknowledgement RSP₁ is sent at time t₄.
   The delay that access point AP₁ introduces from the time it receives probe request PKT₁ to the time access point AP₁ sends out acknowledgement RSP₁ is called the AP delay and is labeled d_{AP}.
      The relationship may be expressed as:
      t₃=t₁+Δ_{AC}+tₐ [1]
where, tₐ is the time offset between access point AP₁ clock and client C clock.

That is, the time at which probe request PKT₁ arrives at access point AP₁ (i.e., time t₃; by access point AP₁ clock) may be equal to the time that probe request PKT₁ was sent (i.e., t₁, measured on client C Clock), plus the time of travel from client C to access point AP₁ (i.e., time interval Δ_{AC}; note that

$${Δ}_{AC} = \frac{{D}_{1}}{c} ;$$

FIG. 1), plus the time offset (tₐ) between access point AP₁ clock and client C clock.
Time t₄: Time measured on AP₁'s clock of instance when Access point AP₁ transmits acknowledgement RSP₁.
Time t₂: Time measured on client C's clock of instance when Client C receives acknowledgement RSP₁.
   The relationship may be expressed as:
   t₂=t₄+Δ_{AC}−tₐ [2]

That is, the time that acknowledgement RSP₁ is received (i.e., t₂ measured on client C clock) may be equal to the time that acknowledgement RSP₁ was sent from access point AP₁ (i.e., t₄ measured on access point AP₁ clock), plus the time of travel from access point AP₁ to mobile M, minus the time offset (tₐ) between access point AP₁ clock and client C clock.

Inspection of time line 22 (FIG. 2) yields the relationship:
t₄−t₃=d_{AP} [3]

That is, the delay introduced by access point AP₁ between receiving probe request PKT₁ and sending acknowledgement RSP₁ may be the AP delay d_{AP}.

Combining Eqns. [1], [2] and [3] gives:

$$\begin{matrix}{t}_{2} - {t}_{1} = [ {t}_{4} + {Δ}_{AC} - {t}_{a} ] - [ {t}_{3} - {Δ}_{AC} - {t}_{a} ] \\ = 2 {Δ}_{AC} + {t}_{4} - {t}_{3} \\ = 2 {Δ}_{AC} + {d}_{AP}\end{matrix} \qquad [ 4 ]$$

Access point AP₂ may be an observer that receives all signals from client C and all signals from access point AP₁ but does not transmit any signals. Observer AP₂ may be embodied in a device other than an access point.
Time t₅: Observer AP₂ receives acknowledgement RSP₁.
   The relationship may be expressed as:
   t₅=t₁+Δ_{OC}+t₀ [5]

That is, the time at which probe request PKT₁ arrives at observer AP₂ (i.e., t₅, measured by observer AP₂ clock) may be equal to the time that probe request PKT₁ was sent (I.e., t₁, measured by client C clock), plus travel time from client C to observer AP₂ (i.e., time interval Δ_{OC}; note that

$${Δ}_{OC} = \frac{{D}_{3}}{c} ;$$

FIG. 1), plus the time offset between client C clock and observer AP₂ clock (t₀).
Time t₆: Observer AP₂ receives acknowledgement RSP₁.
   The relationship may be expressed as:
   t₆=t₄+Δ_{OA}+t₀−tₐ [6]

That is, the time at which acknowledgement RSP₁ arrives at observer AP₂ (i.e., t₆ measured by observer AP₂ clock) may be equal to the time that acknowledgement RSP₁ is sent by access point AP₁ (i.e., t₄ measured by access point AP₁ clock), plus time of travel from access point AP₁ to observer AP₂ (i.e., Δ_{OA}; note that

$${Δ}_{OA} = \frac{{D}_{2}}{c} ;$$

FIG. 1), plus the time offset between access point AP₁ clock and observer AP₂ clock (t₀−tₐ).

Combining Eqns. [5] and [6] gives:

$$\begin{matrix}{t}_{6} - {t}_{5} = [ {t}_{4} + {Δ}_{OA} + {t}_{o} - {t}_{a} ] - [ {t}_{1} + {Δ}_{OC} + {t}_{o} ] \\ = {t}_{4} + {Δ}_{OA} + {t}_{o} - {t}_{a} - {t}_{1} - {Δ}_{OC} - {t}_{o} \\ = [ {t}_{4} - {t}_{a} - {t}_{1} ] + {Δ}_{OA} - {Δ}_{OC}\end{matrix}$$

From Eqn, [2]:
t₄=t₂−Δ_{AC}+tₐ

Substituting Eqn, [2]:

$$\begin{matrix}{t}_{6} - {t}_{5} = [ {t}_{2} - {Δ}_{AC} + {t}_{a} - {t}_{a} - {t}_{1} ] + {Δ}_{OA} - {Δ}_{OC} \\ = [ {t}_{2} - {t}_{1} - {Δ}_{AC} ] + {Δ}_{OA} - {Δ}_{OC}\end{matrix}$$

From Eqn. [4]:
t₂−t₁=2 Δ_{AC}+d_{AP}

Substituting Eqn, [4]:
t₆−t₅=[2 Δ_{AC}+d_{AP}−Δ_{AC}]=Δ_{OA}−Δ_{OC}
t₆−t₅=d_{AP}+Δ_{AC}+Δ_{OA}−Δ_{OC} [7]

Time intervals (t₂−t₁), (t₄−t₃) and (t₆−t₅) may be each respectively measured by independent clocks at access points AP₁, AP₂ and at client C. No synchronization is required to be effected among clocks at AP₁, AP₂ and at client C. Time intervals may be reported or otherwise provided or communicated to a location determination station such as calculation station 12 (FIG. 1). More than one location determination station may be provided. It is preferred that a location determination station be located at one of access points AP₁, AP₂, AP₃. The location determination station can be flexibly located at client C or an access point APₙ or at a remote server (not shown) as desired.

No commonality among timing clocks may be required among various participants AP₁, AP₂, AP₃, C in system 10. That is, no synchronization among clocks in system 10 may be necessary because by calculations described in detail above, clock offsets (e.g., t₀, tₐ) are factored out of calculations. Only locally observed, locally timed intervals are contributed by each participant AP₁, AP₂, AP₃, C to a calculation station 12 for calculating location of client C.

In some systems 10 it may be desired that client C does not send data for inclusion in location calculations. By way of example and not by way of limitation, it may be that a system operator wishes to guard against a client C sending altered or falsified information in order to “hide” its location. If client C does not participate in location determination other than sending probe request PKT₁ (that is, client C does not report its time difference value (t₂−t₁) to a location determination calculation station) but access point AP₁ and observer AP₂ do report their time differences, then one is left with Eqns. [3] and [7] for locating client C:
t₄−t₃=d_{AP} [3]
t₆−t₅=d_{AP}+Δ_{AC}+Δ_{OA}−Δ_{OC} [7]

Regarding Eqn. [3]: Time interval (t₄−t₃) and AP delay d_{AP} may be known without participation by client C. They may be measured by access point AP₁ and therefore may not require participation by client C.

Regarding Eqn. [7]: Time interval (t₆−t₅) and elements d_{AP} and Δ_{OA} may be known without participation by client C.

Elements Δ_{AC} and Δ_{OC} are not known but may be expressed in terms of (x, y) coordinates as known using the Pythagorean Theorem. That is, the position of client C (unknown position (x, y)) may be obtained by solving the following triangulation equations with respect to access points AP₁, AP₂, AP₃.
\sqrt{(x−x₁)²+(y−y₁)²}=D₁; i.e., (x−x₁)²+(y−y₁)²=D₁²
\sqrt{(x−x₂)²+(y−y₂)²}=D₃; i.e., (x−x₂)²+(y−y₂)²=D₃²
\sqrt{(x−x₃)²+(y−y₃)²}=D₄; i.e., (x−x₃)²+(y−y₃)²=D₄²
where D₁ is the distance between access point AP₁ and client C;
   D₃ is the distance between access point AP₂ and client C; and
   D₄ is the distance between access point AP₃ and client C (FIG. 1).

Even though elements Δ_{AC} and Δ_{OC} of Eqn. [7] are not known absolutely, they may be known as a function of (x, y). Accordingly there may be a set of values (x, y) that satisfy the values of elements Δ_{AC} and Δ_{OC} and thereby establish a line of position (LOP) on which client C may be located. Knowing two LOPs (such as by involving more than one access point and observer APₙ (see exemplary cases below) one may locate the position of client C in two dimensions to two distinct locations. Involvement of more access points and observers APₙ may identify more LOPs to effect locating client C uniquely in two or three dimensions. Additional LOPs can also be used to give an over-determined solution that is useful for combating other sources of error such as multipath and diffraction effects.

By way of example and not by way of limitation, some representative cases for employing system 10 are described:

### EXEMPLARY CASE 1

### Client C Participates (i.e., Sends Time Interval Information to Calculation Station 12)

Client C communicates with access point AP₁;
No other access point APₙ is involved.
   Result: Line of position (LOP) is a circle centered on access point AP₁ (radius R₁; FIG. 1).

### EXEMPLARY CASE 2

### Client C Participates (i.e., Sends in Time Interval Information to Calculation Station 12)

Client C communicates with access point AP₁;
Observer AP₂ observes.
   Result: Lines of position (LOPs) are circle and hyperbola.

### EXEMPLARY CASE 3

### Client C Participates (i.e., Sends in Time Interval Information to Calculation Station 12)

Client C communicates with access points AP₁ and AP₂.
   Result: Lines of position (LOPs) are two circles centered on access points AP₁, AP₂ (e.g., radii R₁, R₂; FIG. 1).

### EXEMPLARY CASE 4

### Client C Does Not Participate (i.e., Does Not Send In Time Interval Information to Calculation Station 12)

Client C only sends probe request PKT₁;
Client C communicates with access point AP₁;
Access point AP₁ sends acknowledgement RSP₁;
Observer AP₂ observes.
   Result: Lines of position (LOPs) is one hyperbola.

System 10 may use information that is locally generated at each participating station (e.g., C, AP₁, AP₂, AP₃, APₙ) to calculate unknown distances such as distances D₁, D₃ (via time differences such as Δ_{AC} (related to distance D₁) and Δ_{OC} (related to distance D₃)) so as to generate lines of position (LOPs) for locating client C.

Additional participants may provide additional LOPs for refining location of client C. Each combination of a responding access point (e.g., access point AP₁; FIG. 1)with an observing access point (e.g., access point AP₂; FIG. 1) may produce a hyperbolic LOP. Participation by client C may yield circular LOPs.

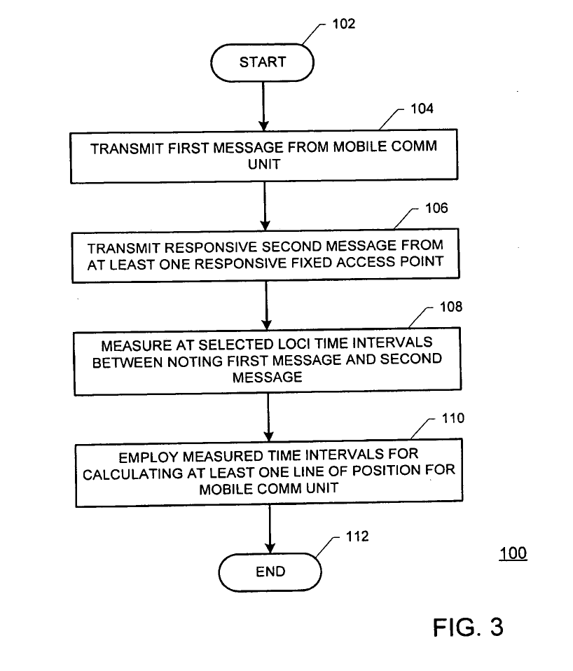

FIG. 3 is a flow diagram illustrating the method of the present invention. In FIG. 3, a method 100 ascertaining location of a mobile communication unit with respect to at least one fixed access point may begin at a START locus 102. Each respective location of each respective access point of the at least one fixed access point is known. Method 100 may continue by transmitting a first message from the mobile communication unit, as indicated by a block 104. Method 100 may continue by transmitting a second message from at least one responsive fixed access point of the at least one fixed access point, as indicated by a block 106. The second message may be responsive to the first message. Method 100 may continue by measuring at selected loci among the mobile communication unit and the at least one fixed access point time intervals between noting the first message and noting the second message, as indicated by a block 108. Method 100 may continue by employing the measured time intervals at the selected loci for calculating at least one line of position locating the mobile communication unit, as indicated by a block 110. Method 100 may terminate at an END locus 112.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method ascertaining location of a mobile communication unit with respect to at least one fixed access point; each respective location of each respective access point of said at least one fixed access point being known; the method comprising:
(a) transmitting a first message from said mobile communication unit;
(b) transmitting a second message from at least one responsive fixed access point of said at least one fixed access point; said second message being responsive to said first message;
(c) measuring at selected stations among said mobile communication unit and said at least one fixed access point time intervals between noting said first message and noting said second message; and
(d) employing said measured time intervals at said selected stations or calculating at least one line of position locating said mobile communication unit.

2. A method ascertaining location of a mobile communication unit with respect to at least one fixed access point as recited in claim 1 wherein said selected stations include said mobile communication unit.

3. A method ascertaining location of a mobile communication unit with respect to at least one fixed access point as recited in claim 1 wherein said selected stations include a first fixed access point of said at least one fixed access point and a second fixed access point of said at least one fixed access point; said first fixed access point being said responsive fixed access point.

4. A method ascertaining location of a mobile communication unit with respect to at least one fixed access point as recited in claim 1 wherein said calculating is effected at a calculating position; participating units among said mobile communication unit and said at least one fixed access point communicating information for said calculating to said calculating position.

5. A method ascertaining location of a mobile communication unit with respect to at least one fixed access point as recited in claim 2 wherein said calculating is effected at a calculating position; participating units among said mobile communication unit and said at least one fixed access point communicating information for said calculating to said calculating position.

6. A method ascertaining location of a mobile communication unit with respect to at least one fixed access point as recited in claim 2 wherein said selected stations do not include said mobile communication unit and wherein said calculating is effected at a calculating position; participating units among said at least one fixed access point communicating information for said calculating to said calculating position.

7. A method locating a mobile communication unit with respect to at least one fixed access point; the method comprising:
(a) transmitting a first message from said mobile communication unit;
(b) transmitting a responsive message from at least one responsive fixed access point of said at least one fixed access point after said first message is received at said at least one responsive fixed access point;
(c) measuring at selected stations among said mobile communication unit and said at least one fixed access point a respective time interval between noting said first message and noting said responsive message; said measuring being effected using a respective local clock at each respective said selected station;
(d) providing said respective time intervals to a calculating unit; and
(e) operating said calculating unit to calculate at least one line of position locating said mobile communication unit.

8. A method locating a mobile communication unit with respect to at least one fixed access point as recited in claim 7 wherein said selected stations include said mobile communication unit.

9. A method locating a mobile communication unit with respect to at least one fixed access point as recited in claim 7 wherein said selected stations include a first fixed access point of said at least one fixed access point and a second fixed access point of said at least one fixed access point; said first fixed access point being said responsive fixed access point.

10. A method locating a mobile communication unit with respect to at least one fixed access point as recited in claim 9 wherein said selected stations do not include said mobile communication unit.

11. A method locating a mobile communication unit with respect to at least one fixed access point as recited in claim 9 wherein said second fixed access point operates as an observer station; said observer station not actively participating in sending messages for effecting said locating.

12. A method locating a mobile communication unit with respect to at least one fixed access point as recited in claim 10 wherein said second fixed access point operates as an observer station; said observer station not actively participating in sending messages for effecting said locating.

13. A system locating a mobile communication unit with respect to at least one fixed access point; the method comprising:
(a) a first transmitting unit transmitting a first message from said mobile communication unit;
(b) at least one second transmitting unit transmitting a responsive message from at least one responsive fixed access point of said at least one fixed access point after said first message is received at said at least one responsive fixed access point;
(c) a respective local clock at selected stations among said at least one fixed access point and said mobile communication unit for measuring at said selected stations a respective time interval between noting said first message and noting said responsive message; and
(d) at least one data communication unit providing said respective time intervals to a calculating unit; said calculating unit being configured for using said time intervals to calculate at least one line of position locating said mobile communication unit.

14. A system locating a mobile communication unit with respect to at least one fixed access point as recited in claim 13 wherein said selected stations include said mobile communication unit.

15. A system locating a mobile communication unit with respect to at least one fixed access point as recited in claim 13 wherein said selected stations include a first fixed access point of said at least one fixed access point and a second fixed access point of said at least one fixed access point; said first fixed access point being said responsive fixed access point.

16. A system locating a mobile communication unit with respect to at least one fixed access point as recited in claim 15 wherein said selected stations do not include said mobile communication unit.

17. A system locating a mobile communication unit with respect to at least one fixed access point as recited in claim 15 wherein said second fixed access locus operates as an observer station; said observer station not actively participating in sending messages for effecting said locating.

18. A system locating a mobile communication unit with respect to at least one fixed access point as recited in claim 16 wherein said second fixed access locus operates as an observer station; said observer station not actively participating in sending messages for effecting said locating
